(19) United States
(12) Patent Application Publication
(10) Pub. No.: US 2007/0067575 A1
(43) Pub. Date: Mar. 22, 2007

(54) METHOD OF MANAGING CACHE MEMORY BASED ON DATA TEMPERATURE

(76) Inventors: John Mark Morris, San Diego, CA (US); Bhashyam Ramesh, Secunderabad (IN)

Correspondence Address: JAMES M. STOVER;NCR CORPORATION, 1700 SOUTH PATTERSON BLVD, WHQ4, DAYTON, OH, 45479, US

(21) Appl. No.: 11/470,710

(22) Filed: Sep. 7, 2006

Related U.S. Application Data
(60) Provisional application No. 60/718,835, filed on Sep. 20, 2005.

(51) Int. Cl. G06F 12/00

(52) U.S. Cl. 711/133

(57) ABSTRACT

A technique for use in managing a data cache involves receiving one or more data objects to be written to a storage device. A temperature value is assigned to the one or more data objects before storing the data objects in the data cache. The temperature value assigned to the one or more data objects is compared with a threshold value. A copy of the one or more data objects is stored in the data cache if the assigned temperature value exceeds the threshold value.

### CROSS-REFERENCE TO RELATED APPLICATION

This application claims benefit of U.S. Provisional Application 60/718,835, filed on Sep. 20, 2005.

### BACKGROUND

Computer systems generally include one or more processors interfaced to a temporary data storage device such as a memory device and one or more persistent data storage devices such as disk drives. Many such computer systems maintain a data cache in a memory hierarchy. The purpose of the data cache is to store copies of data objects in the data cache that are most likely to be next retrieved from the disk drives.

The difficulty facing effective cache management is in predicting which data objects will be next retrieved from the disk drives. It is common for such caches of data to be managed by a combination of simple techniques. One such technique is to determine, when considering whether or not to add a copy of a data object to the data cache, whether or not the data object is likely to be retrieved from the disk drive. Objects that are likely to be retrieved from the disk drive are classified as “cacheable” and stored in the data cache. Those data objects that are unlikely to be retrieved from a disk drive are not classified as cacheable and are not stored in the data cache.

Another simple technique of data cache management involves removing a data object from the data cache when attempting to add a data object to the data cache that would otherwise exceed the fixed size of the data cache. In many data caches, the date and/or time that the data object was last retrieved from the disk drives will be stored. The data object removed from the cache is often the least recently used (LRU) data object in the cache. The data objects will range from the most recently retrieved data object or most recently used (MRU) object to the least recently retrieved or least recently used (LRU) object. The assumption with this technique is that the most recently received data objects in the data cache are more likely to be required to be retrieved from the disk drives than those least recently retrieved or used.

One disadvantage with the LRU management technique is apparent when a user performs a large query on a database that may involve data of a greater age than that normally required by the user. A cache management technique that is based solely on a least recently used algorithm is vulnerable to having the data cache flushed and replaced with the results of the large query. This would mean that those data objects that would normally be retained in the data cache are removed from the data cache.

### SUMMARY

Described below is a method of managing a data cache that can be used as an alternative or as an addition to existing cache management techniques. One technique described below involves receiving one or more data objects to be written to a storage device. A temperature value is assigned to the one or more data objects before storing the data objects in the data cache. The temperature value assigned to the one or more data objects is compared with a threshold value. A copy of the one or more data objects is stored in the data cache if the assigned temperature value exceeds the threshold value.

In some cases the data objects will already be associated with a temperature value. A method of managing a data cache is also described that involves receiving one or more data objects to be written to a storage device where the data objects are already associated with a temperature value. The associated temperature values are compared with a threshold value. A copy of the one or more data objects is stored in the data cache if the assigned temperature value exceeds the threshold value.

Also described below are methods of managing a data cache that involve selecting certain data objects to be removed from the data cache. In one form, a method of managing the data cache associated with a plurality of data objects written to a storage device is described. Respective temperature values for one or more of the plurality of data objects are maintained in computer memory. The temperature values associated with one or more data objects are compared with a threshold value. Any data objects having an associated temperature value lower than the threshold value are deleted from the cache.

If more than one data object in the data cache matches the required threshold value, then the least recently used data object in some systems is deleted from the data cache or alternatively all data objects matching the threshold are deleted from the cache. If no data objects in the data cache have a temperature value lower than the threshold value, then the threshold value is increased and a further iteration performed.

In each of the above techniques, the temperature value is obtained from a user, referred to as a user-specified temperature value, or the temperature value is calculated by an automated process, referred to as a system-specified temperature value. The temperature value and threshold value in some systems are selected from an ordered set of temperature values or alternatively the temperature value and threshold value are a numerical value.

### BRIEF DESCRIPTION OF THE DRAWINGS

FIG. 1 is a block diagram of a computer system having a data cache memory.

FIG. 2 is a flow chart of a technique for selecting which data blocks to add to a cache.

FIG. 3 is a flow chart of a technique for selecting data blocks to remove from a data cache.

FIG. 4 is a block diagram of data objects having associated temperature values.

FIG. 5 is a block diagram of an exemplary large computer system in which the techniques described below are implemented.

### DETAILED DESCRIPTION

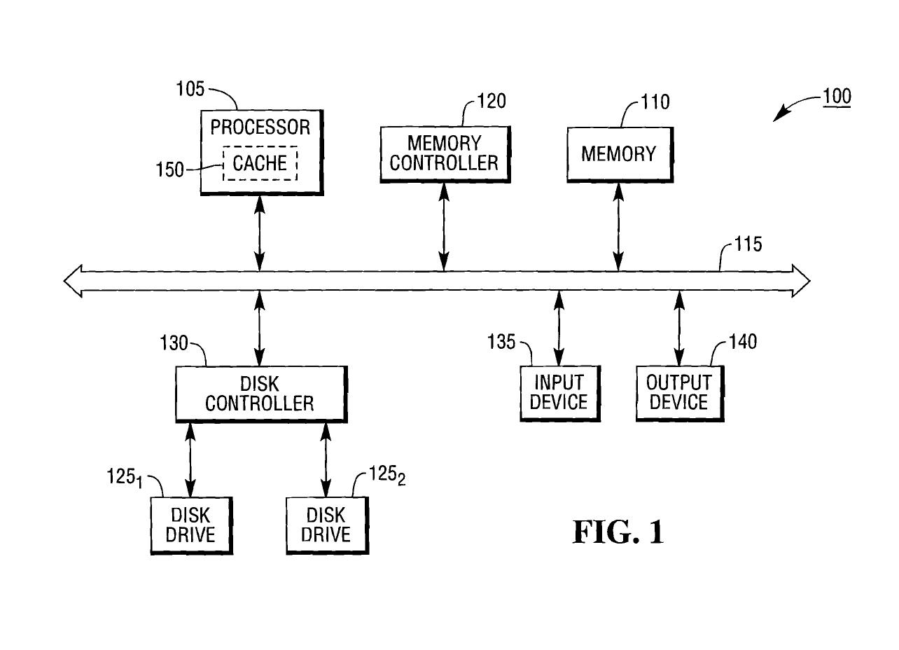

FIG. 1 shows a computer system 100 suitable for implementation of a method of data cache management. The system 100 includes one or more processors 105 that receive data and program instructions from a temporary data-storage device, such as a memory device 110, over a communications bus 115. A memory controller 120 governs the flow of data into and out of the memory device 110. The system 100 also includes one or more persistent data-storage devices, such as disk drives 125₁ and 125₂ that store chunks of data or data objects in a manner prescribed by one or more disk controllers 130. One or more input devices 135, such as a mouse and a keyboard, and output devices 140, such as a monitor and a printer, allow the computer system to interact with a human user and with other computers.

On instructions from the memory controller 120, data objects are retrieved via the disk controller(s) 130 from the disk drives 125. The retrieved data objects are stored in memory 110 for subsequent access by the processor 105. Repeated requests for data from the disk drives can affect the performance of the computer system 100 due to the delay in retrieving data objects from the disk drives. System 100 in one form includes a data cache 150 that typically resides on processor(s) 105, one of the disk drives and/or memory 110. The data cache 150 maintains a copy of certain data objects retrieved or written to the disk drives. The intention of the data cache is to speed up performance of the system 100 by reducing the number of data objects retrieved from the disk drives 125. If copies of these data objects are readily available to the processor 105 from the cache 150, then the need to retrieve those objects from the disk drives is reduced.

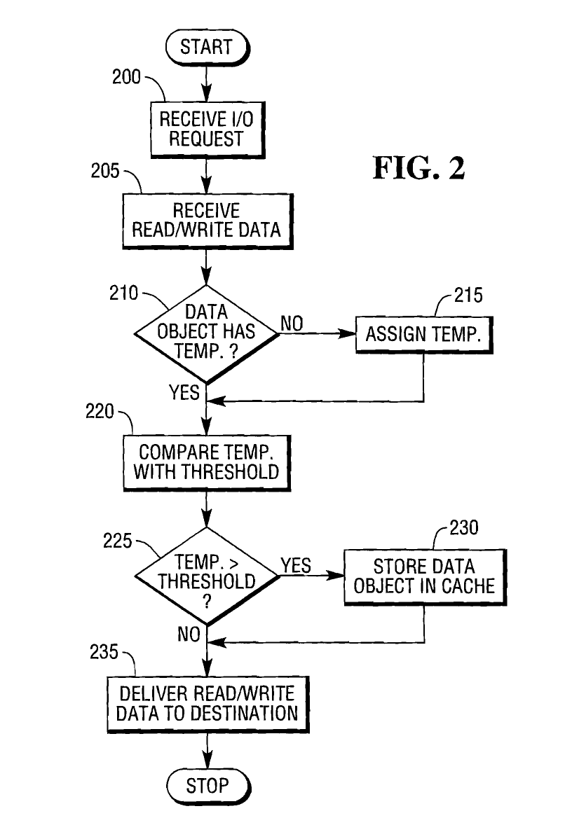

FIG. 2 shows an example of one technique of selecting data objects to be added to a data cache. Upon receiving an I/O request from a requesting device (step 200), the system either receives one or more data objects to be written to a storage device from the requesting device in the case of a write request, or retrieves one or more data objects from storage in the case of a read request (step 205).

One technique involves associating data objects with a temperature value. The temperature values are selected such that data objects with a relatively high temperature value are likely to be accessed from a storage device, whereas data objects having a relatively low temperature are unlikely to be accessed. A temperature value is an artificial value assigned to a data object to represent the access rate or potential access rate of that data object. An analogy can be drawn between the temperature value assigned to a data object and a physical object. A physical object that is passed through a congested pipe encounters friction and experiences an increase in physical temperature. During periods where the physical object remains stationary, it is not subject to friction and the physical temperature of the physical object drops. In this regard, a temperature value assigned to a data object represents the movement of that data object between disk drives 125, memory 110 and data cache 150.

In one form the temperature values are selected from an ordered set of temperature values. In one example the ordered set represents four temperature grades, namely HOT-PACING, HOT, WARM and COOL. The set is preferably ordered so that a temperature of HOT-PACING has a higher value assigned to it than the temperature of COOL. It will be appreciated that the terminology for each grade and the number of temperature values in the ordered set could be varied.

As an alternative, the temperature value is a numerical value, for example a temperature in Fahrenheit. A temperature of 0° F. is assigned to a data object that is unlikely to be retrieved or accessed from the disk drive whereas a data object that will almost certainly be required to be retrieved or accessed from the disk drive is assigned a temperature value of 200° F. for example.

The data object that is the subject of the I/O request is checked (step 210) to determine whether or not the data object has an associated temperature value. If the data object does not have an associated temperature value, the technique in one form assigns a temperature value to the data object or data objects (step 215). In one form the temperature value is simply assigned to the data object based on the object type. Some data objects such as spool data and indexes tend to be accessed more often than other data object types. In this way, a series of rules could be applied that assigns a temperature value to a data object based on data type. Such a system specified temperature value is assigned to a data object so that data types such as spool data and indexes are assigned a relatively hot temperature value whereas other types of data are assigned a relatively low temperature value.

In one form the rules applied are as follows:
IF object_type IN (Queue table, WAL Log, WAL Depot, Journal, System table) THEN
   assign HOT-PACING temperature to data object
ELSE
IF object_type IN (Spool table, temporary table, secondary index)THEN
   Assign HOT temperature to data object
ELSE
IF object_type IN (user table) THEN
   assign WARM temperature to data object
ELSE
   assign COLD temperature to data object

In another form the rules applied are as follows:
IF object_type IN (Queue table, WAL Log, WAL Depot, Journal, System table) THEN
   assign temperature 200 to data object
ELSE
IF object_type IN (Spool table, temporary table, secondary index) THEN
   Assign temperature 150 to data object
ELSE
IF object_type IN (user table) THEN
   assign temperature 100 to data object
ELSE
   assign temperature 50 to data object.

The technique in one form also involves obtaining from a human user a user-specified temperature value. For example, using an output device, the user is presented with data representing one or more data objects. Using the input device, the user in one form of the system specifies a temperature value for one or more of these data objects. User-specified temperature values are alternatively or additionally obtained by allowing the user to specify a certain class or type of data objects to which a certain temperature value should be assigned. The benefit of obtaining a user-specified temperature value is the potential to avoid placing data objects in a data cache that would be classified as cacheable based on object type but that are unlikely to be used during the lifetime of the data cache.

It is also envisaged that in some systems a data object that already has a temperature value is assigned a new temperature value. For example, the technique assigns to a data object that has recently been retrieved from or written to the disk drives a higher temperature value than that already assigned to it. Similarly, the technique assigns to a data object that has not recently be retrieved from or written to the disk drives a lower temperature value than that already assigned to it. In such a system, an automated process calculates a higher or lower temperature to assign to the data object.

In another form every data object is assigned a HOT temperature initially and the temperature of the data object is either raised or lowered depending on the access rate of the data object. In a further alternative the data object inherits the temperature value of other data objects or collections of data with which the data object is stored in the disk drives.

Once the temperature value of the data object has been established, the temperature value is compared with a threshold value (step 220) to determine whether or not the data object should be stored in the cache. Depending on the comparison (step 225) between the temperature value of the data object and the threshold value, a decision is then made whether or not to store the data object in the cache. The comparison is carried out in any suitable manner. For example, if the temperature value has been selected from the ordered set of HOT-PACING, HOT, WARM and COOL, the threshold value could be the temperature value WARM. All data objects that have the temperature HOT-PACING or HOT would be stored in the cache and all data objects that are either WARM or COOL would not be stored in the cache. All data objects having a temperature value greater than WARM would be cached and those having a temperature value equal to or cooler than the threshold value would not be cached.

It will be appreciated that the comparison in one form tests whether or not the temperature value of a data object is greater than or equal to a threshold value. In this situation, the threshold value could be “HOT” and all data objects having a temperature value of either HOT-PACING or HOT would be cached, whereas those data objects having a temperature value less than the threshold value, namely WARM or COOL, would not be cached.

It will also be appreciated that the test in another form determines whether or not the temperature value of a data object is less than a threshold value or less than or equal to a threshold value. If the test is satisfied, the data object would not be stored in the cache, otherwise the data object would be stored in the cache.

If the temperature value of the data object is of a sufficient temperature determined by the test set out in step 225, the data object is stored in the cache (step 230).

The system then delivers the read/write data to the appropriate destination (step 235). If the system has received a request to write data to disk, then the data objects will be delivered to the appropriate location on the disk. If the system has received a request for a read operation, then the data objects will be delivered to the requesting device.

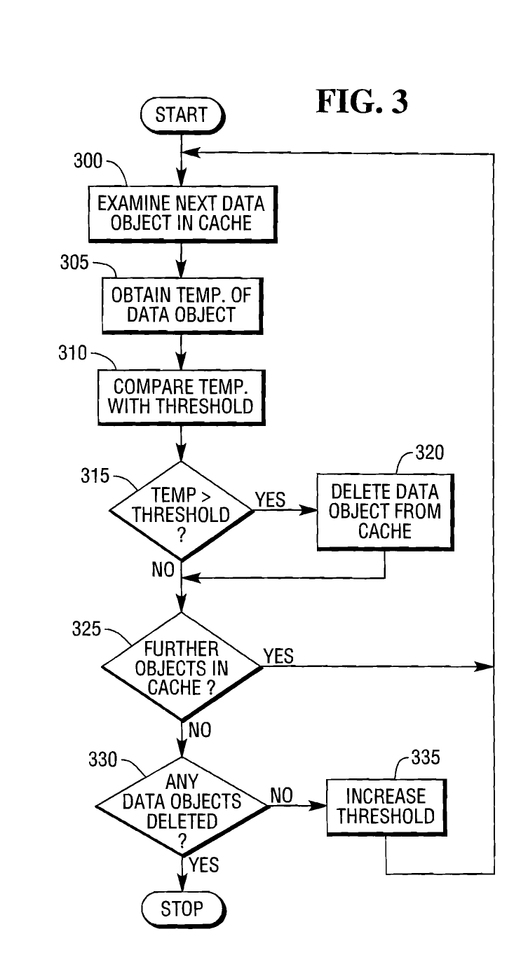

Another important technique for managing a data cache is in deleting data objects from the data cache that are unlikely to be the subject of a further I/O request. FIG. 3 shows an example of one technique of selecting data blocks to remove from a data cache. The technique could be used a replacement to augment a conventional least recently used (LRU) technique, as described below. The next data object in the cache is examined (step 300). This will initially be the first data object. Where the data object is associated with a data temperature, that data temperature is obtained (step 305) from the data object. It is anticipated that the respective temperature values for one or more of the data objects in the cache are maintained or stored in computer memory. The data temperature is stored with the data object in the cache 150 or alternatively is stored in any other suitable structure.

The technique first identifies all data objects having a certain threshold data temperature. This is performed in one form by comparing the current data object in the cache with the threshold value (step 310) to determine whether or not the data temperature is equal to the threshold value (step 315). It is anticipated that the threshold value would be set to a low data temperature initially. For example, where there is an ordered set of temperature values of HOT-PACING, HOT, WARM and COOL, the initial threshold temperature could be set to COOL. If there is only one COOL object, then this data object is deleted from the cache (step 320). If there are more than one data objects in the data cache having the same threshold data temperature, then a suitable selection procedure decides which data object to delete or evict from the cache. In one simple technique, all data objects having the threshold data temperature are deleted from the data cache.

The technique could be used to augment an LRU aging algorithm. In one form, temporal data representing the order in which data objects have been retrieved from the storage device are maintained in computer memory. In this way, it can be determined from a set of data objects which data object has been most recently retrieved, and which data object has been least recently retrieved. Where more than one data object in the data cache has a threshold temperature value, the data object that has been least recently used is deleted from the cache.

If the data object under examination has a data temperature that exceeds the threshold, the data object is not deleted from the cache. The technique then determines whether or not there are further data objects in the cache to examine (step 325) and if so, the next data object in the cache is examined (step 300).

Once all data objects in the data cache have been examined, the technique then examines whether or not any of the data objects in the cache matched the threshold (step 330), resulting in data objects being deleted from the cache. If there are no data objects in the data cache that matched the current threshold, then the threshold value is increased (step 335) and the first data object in the cache examined (step 300).

In this way, the technique first looks for any COOL objects. If such objects exist, the least recently used COOL data object is evicted. Otherwise, if any WARM objects exist, then the least recently used WARM data object is evicted. Otherwise, if any HOT objects exist in the data cache, the least recently used HOT data object is evicted. Otherwise, the least recently used HOT-PACING data object in the cache is evicted.

It is also envisaged that a data object having an associated temperature value is assigned a new temperature value. For example in one form, the technique assigns to a data object that has not recently been retrieved from or written to the disk drives a lower temperature value than that already assigned to it. Such data objects are then removed from the data cache on a further iteration of the technique described above. Similarly, a data object that has recently been retrieved from or written to the disk drives has assigned to it a higher temperature value than that already assigned. The new temperature value is calculated by an automated process.

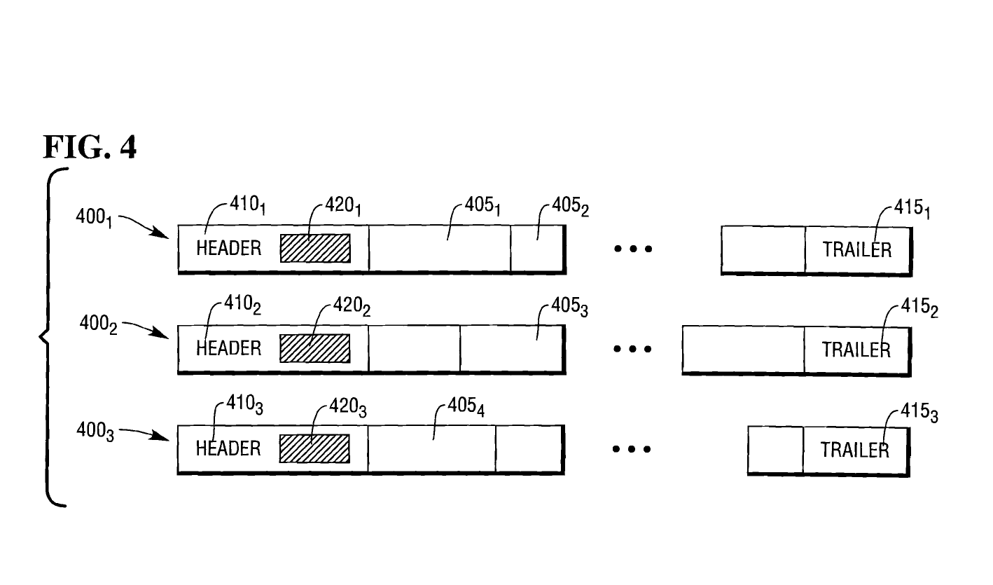

FIG. 4 shows several data chunks or data objects 400_{1 . . . 3} stored on a disk drive 125. Each of the blocks shown here includes several data segments 405_{1 . . . 4} of equal length (eg 512 bytes per data object). The blocks do not necessarily include an equal number of segments. Each data object 400 includes a header 410_{1 . . . 3} and a trailer 415_{1 . . . 3} marking the beginning and end of each data object respectively. In some systems as shown in FIG. 4, the temperature value 420_{1 . . . 3} is encoded as a small byte sequence within each header 410. In this way, temperature values of one or more data objects in a cache are maintained or stored in computer memory.

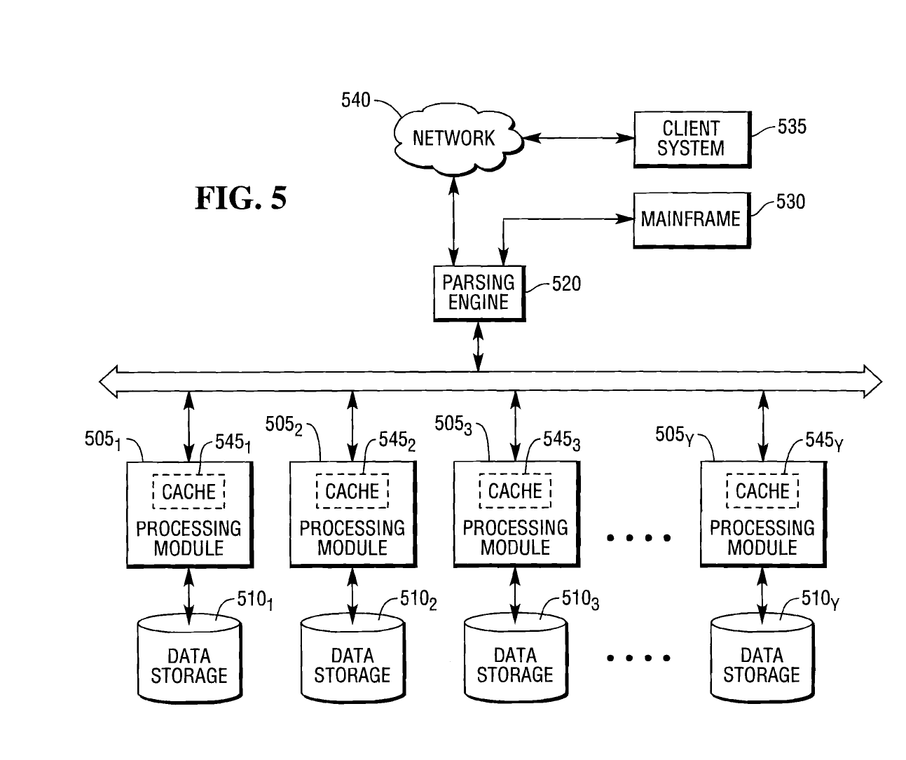

FIG. 5 shows an example of one type of computer system in which the above techniques of data cache management is implemented. The computer system is a data warehousing system 500, such as a TERADATA data warehousing system sold by NCR Corporation, in which vast amounts of data are stored on many disk-storage facilities that are managed by many processing units. In this example, the data warehouse 500 includes a relational database management system (RDBMS) built upon a massively parallel processing (MPP) platform. Other types of database systems, such as object-relational database management systems (ORDBMS) or those built on symmetric multi-processing (SMP) platforms, are also suited for use here.

As shown here, the data warehouse 500 includes one or more processing modules 505_{1 . . . y} that manage the storage and retrieval of data in data-storage facilities 510_{1 . . . y}. Each of the processing modules 505_{1 . . . y} manages a portion of a database that is stored in a corresponding one of the data-storage facilities 510_{1 . . . y}. Each of the data-storage facilities 510_{1 . . . y} includes one or more disk drives.

A parsing engine 520 organises the storage of data and the distribution of data objects stored in the disk drives among the processing modules 505_{1 . . . y}. The parsing engine 520 also coordinates the retrieval of data from the data storage facilities 510_{1 . . . y} in response to queries received from a user at a mainframe 530 or a client computer 535 through a wired or wireless network 540. A data cache 545_{1 . . . y} managed by the techniques described above is stored in the memory of the processing modules 505_{1 . . . y}.

The text above describes one or more specific embodiments of a broader invention. The invention also is carried out in a variety of alternative embodiments and thus is not limited to those described here. Those other embodiments are also within the scope of the following claims.

I claim:

1. A method of managing a data cache, the method comprising:
receiving one or more data objects to be written to a storage device;
assigning a temperature value to the one or more data objects;
comparing the temperature value assigned to the one or more data objects with a threshold value; and
storing a copy of the one or more data objects in the data cache if the assigned temperature value exceeds the threshold value.

2. The method of claim 1 wherein the step of assigning a temperature value to the one or more data objects includes the steps of:
obtaining from a user a user specified temperature value; and
assigning the user specified temperature value to the one or more data objects.

3. The method of claim 1 wherein the step of assigning a temperature value to the one or more data objects includes the steps of:
calculating a system specified temperature value; and
assigning the system specified temperature value to the one or more data objects.

4. The method of claim 3 wherein the step of calculating a system specified temperature value is based at least partly on a data object type associated with the one or more data objects.

5. The method of claim 1 wherein the temperature value is selected from an ordered set of temperature values.

6. The method of claim 5 wherein the threshold value is selected from the ordered set of temperature values.

7. The method of claim 1 wherein the temperature value is a numerical value.

8. The method of claim 7 wherein the threshold value is a numerical value.

9. A method of managing a data cache, the method comprising:
receiving one or more data objects to be written to a storage device, the data object(s) associated with respective temperature values;
comparing the temperature value associated with one or more data objects with a threshold value; and
storing a copy of the one or more data objects in the data cache if the assigned temperature value exceeds the threshold value.

10. The method of claim 9 wherein the temperature value has been specified by a user.

11. The method of claim 9 wherein the temperature value has been calculated by an automated process.

12. The method of claim 9 wherein the temperature value has been selected from an ordered set of temperature values.

13. The method of claim 12 wherein the threshold value has been selected from the ordered set of temperature values.

14. The method of claim 9 wherein the temperature value is a numerical value.

15. The method of claim 14 wherein the threshold value is a numerical value.

16. A method of managing a data cache associated with a plurality of data objects written to a storage device, the method comprising:
maintaining respective temperature values for one or more of the plurality of data objects;
comparing the temperature value(s) associated with the one or more data objects with a threshold value; and
deleting one or more data objects from the data cache if the associated temperature value is lower than the threshold value.

17. The method of claim 16 further including the step of increasing the threshold value if no data objects in the data cache have an associated temperature value lower than the threshold value.

18. The method of claim 16 wherein the temperature value has been specified by a user.

19. The method of claim 16 wherein the temperature value has been calculated by an automated process.

20. The method of claim 16 wherein the temperature value has been selected from an ordered set of temperature values.

21. The method of claim 20 wherein the threshold value has been selected from the ordered set of temperature values.

22. The method of claim 16 wherein the temperature value is a numerical value.

23. The method of claim 22 wherein the threshold value is a numerical value.

24. A method of managing a data cache associated with a plurality of data objects written to a storage device, the method comprising:
maintaining respective temperature values for one or more of the plurality of data objects;
maintaining temporal data representing the order in which data objects have been retrieved from the storage device;
identifying the data objects in the data cache having an associated temperature value lower than a threshold value; and
deleting, from the data cache, the one or more data objects from the identified data objects that have been least recently retrieved from the storage device.

25. The method of claim 24 further including the step of increasing the threshold value if no data objects in the data cache have an associated temperature value lower than the threshold value.

26. The method of claim 24 wherein the temperature value has been specified by a user.

27. The method of claim 24 wherein the temperature value has been calculated by an automated process.

28. The method of claim 24 wherein the temperature value has been selected from an ordered set of temperature values.

29. The method of claim 28 wherein the threshold value has been selected from the ordered set of temperature values.

30. The method of claim 24 wherein the temperature value is a numerical value.

31. The method of claim 30 wherein the threshold value is a numerical value.
